(19) United States
(12) Patent Application Publication
(10) Pub. No.: US 2003/0084191 A1
(43) Pub. Date: May 1, 2003

(54) IP multicast relay system

(75) Inventor: Takaya Yamamoto, Tokyo (JP)

Correspondence Address: STAAS & HALSEY LLP, 700 11TH STREET, NW, SUITE 500, WASHINGTON, DC, 20001, US

(73) Assignee: JAPAN CABLENET LIMITED, Tokyo (JP)

(21) Appl. No.: 10/278,859

(22) Filed: Oct. 24, 2002

(30) Foreign Application Priority Data
Oct. 29, 2001 (JP) 2001-331578
Sep. 26, 2002 (JP) 2002-282018

(51) Int. Cl. G06F 15/16

(52) U.S. Cl. 709/249; 709/217

(57) ABSTRACT

An IP multicast relay system includes a center and subscriber systems connected by an IP network. There is provided a transmission network that connects the center and the subscriber systems. Multicast data of a particular multicast address bypasses the IP network and is sent to the subscriber systems via the transmission network.

### BACKGROUND OF THE INVENTION

1. Field of the invention

The present invention generally relates to broadcasting systems that utilize the IP (Internet Protocol) multicast function. More particularly, the present invention relates to an IP multicast relay system capable of providing subscribers connected to a center via a transmission network with IP multicast services and to a communication system and a communication apparatus suitable for the above IP multicast relay system.

2. Description of the Related Art

IP multicast is known as a technique of delivery of streaming such as video over the IP network.

IP multicast is not connection-oriented communications but is a protocol for delivering data to multicast group members. The multicast address represents a multicast group, and uses class-D addresses ranging from 224.0.0.0 to 239.255.255.255. The individual hosts can join and withdraw from the multicast group any time. There are no physical and local limitations about members.

The router that supports IP multicast detects the presence of a host that joins the multicast group, and delivers (sends) multicast data of the above-mentioned multicast group to only the network to which the host is connected. The protocol for detecting the host is IGMP (Internet Group Management Protocol: RFC1112).

In recent years, switching hubs have the function of inhibiting multicast data from being delivered (sent) to a port via which no host that joins the multicast group is available. The above function is called IGMP snooping function.

Although it can be said that the recent IP networks are broadband networks, the existing networks do not have a sufficient transmission capacity for broadcasting/video delivering over the IP network.

Even a case where video having an image quality realized by WidowsMedia or RealVideo as high as DVD needs a transmission band of approximately 700 Kbps per program. If such video is delivered using a cable modem system (30 Mbps:ITU J.112 Annex B specification), only 42 programs (30 Mbps/700 Kbps) can be delivered at maximum even when the multicast technique is employed. However, in practice, 500 through 1000 subscribers are accommodated in the transmission band in the cable modem system. It is therefore apparent that the currently available transmission band is insufficient even if plural persons watch the same program simultaneously. Further, in the future, a transmission band of 20 Mbps per program would be needed to deliver a high definition television program using an advanced technique such as MPEG2.

### SUMMARY OF THE INVENTION

Taking into consideration the above, it is therefore an object of the present invention to provide a broadband multicast system and a communication apparatus and a communication method suitable for the broadband multicast system.

The above object of the present invention is achieved by an IP multicast relay system including: a center and subscriber systems connected thereto via both an IP network and a transmission network; a center sender provided in the center, the center sender receiving multicast data having a particular multicast address via a center LAN to which a multicast server that sends multicast data to the center LAN is connected and relaying the multicast data thus received to the transmission network; a filter unit that is connected between the center LAN and the IP network and prevents the multicast data having the particular multicast data from being sent to the IP network; and a receiver unit provided in the subscriber system, the receiver unit receiving the multicast data via the transmission network and sending the multicast data thus received to a subscriber LAN to which the IP network and a multicast receiver terminal are connected.

The transmission network serves as a bypass network via which multicast data of a particular multicast address is sent to the subscriber systems so as to bypass the IP network. Hence, the system is substantially independent of the transmission band of the IP network.

### BRIEF DESCRIPTION OF THE DRAWINGS

Other objects, features and advantages of the present invention will become more apparent from the following detailed description when read in conjunction with the accompanying drawings, wherein like reference numerals refer to like elements throughout:

FIG. 1 is a block diagram illustrating the principles of the IP multicast relay system of the present invention;

FIG. 2 is a sequence diagram of the operation of the IP multicast relay system shown in FIG. 1;

FIG. 3 is a block diagram of the configuration of an IP multicast relay system according to a first embodiment of the present invention;

FIG. 4 is a sequence diagram of the operation of the IP multicast relay system shown in FIG. 3;

FIG. 5 is a block diagram of the configuration of an IP multicast relay system according to a second embodiment of the present invention;

FIG. 6 is a sequence diagram of the operation of the IP multicast relay system shown in FIG. 5;

FIG. 7 is a block diagram of an IP multicast system according to a third embodiment of the present invention;

FIG. 8 is a sequence diagram of the operation of the IP multicast system shown in FIG. 7;

FIG. 9 illustrates an example of a table shown in FIG. 7;

FIG. 10 is a block diagram of an IP multicast relay system according to a fourth embodiment of the present invention;

FIG. 11 is a block diagram of the configuration of a center sender shown in FIG. 10;

FIG. 12 illustrates an example of routing (switching) performed by the center sender shown in FIGS. 10 and 11;

FIG. 13 is a sequence diagram of the IP multicast system shown in FIG. 10;

FIG. 14 is a block diagram of the configuration of an IP multicast relay system according to a fifth embodiment of the present invention;

FIG. 15 is a block diagram of the configuration of an IP multicast relay system according to a sixth embodiment of the present invention; and

FIG. 16 is a block diagram of the configuration of an IP multicast relay system according to a seventh embodiment of the present invention.

### DESCRIPTION OF THE PREFERRED EMBODIMENTS

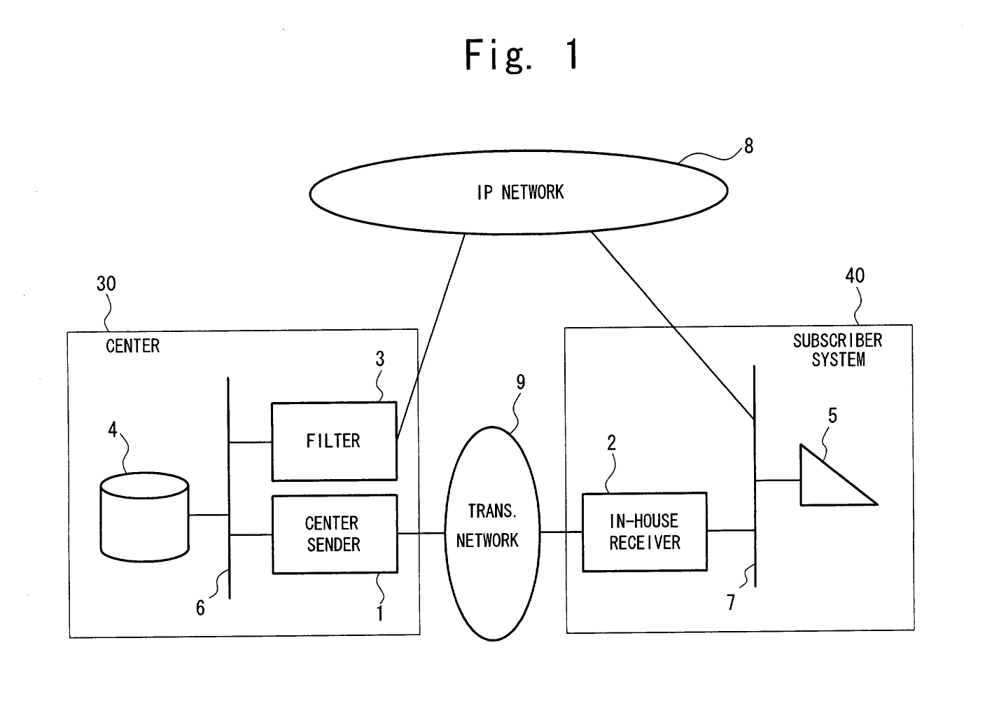

First, a description will be given of the principles of the present invention with reference to FIG. 1.

Referring to FIG. 1, a center 30 and a subscriber system 40 are connected together by an IP network 8 and a transmission network 9, which may, for example, be a transmission line. The transmission network 9 is used to bypass the IP network 8 to send multicast data having a particular multicast address to the subscriber system 40, as will be described in detail below.

The center 30 includes a center sender 1, a filter unit 3 and a multicast server 4. Although the multicast server 4 is not required to be installed in the center 30, the server 4 may directly be connected, without the IP network 8, to the center 30 via a channel extending from an IDC center (not shown for the sake of simplicity). The center sender 1 is interposed between a center LAN (Local Area Network) 6 and the transmission network 9, and are connected thereto. The filter unit 3 is interposed between the center LAN 6 and the IP network 8, and is connected thereto. The center sender 1 has the function of relaying multicast data specified by a particular multicast address. The filter unit 3 discards the multicast data of the particular multicast address.

At the subscriber system 40, there are provided an in-house receiver unit 2 and a multicast receiver terminal 5, which may be a personal computer. The IP network 8 and the multicast receiver terminal 5 are connected via a subscriber LAN 7. The in-house receiver unit 2 is connected between the LAN 7 and the transmission network 9. The multicast receiver terminal 5 has a Web navigation function in addition to the function of receiving multicast data, although the navigation function is not essential. The in-house receiver unit 2 has the function of relaying multicast data to the subscriber LAN 7.

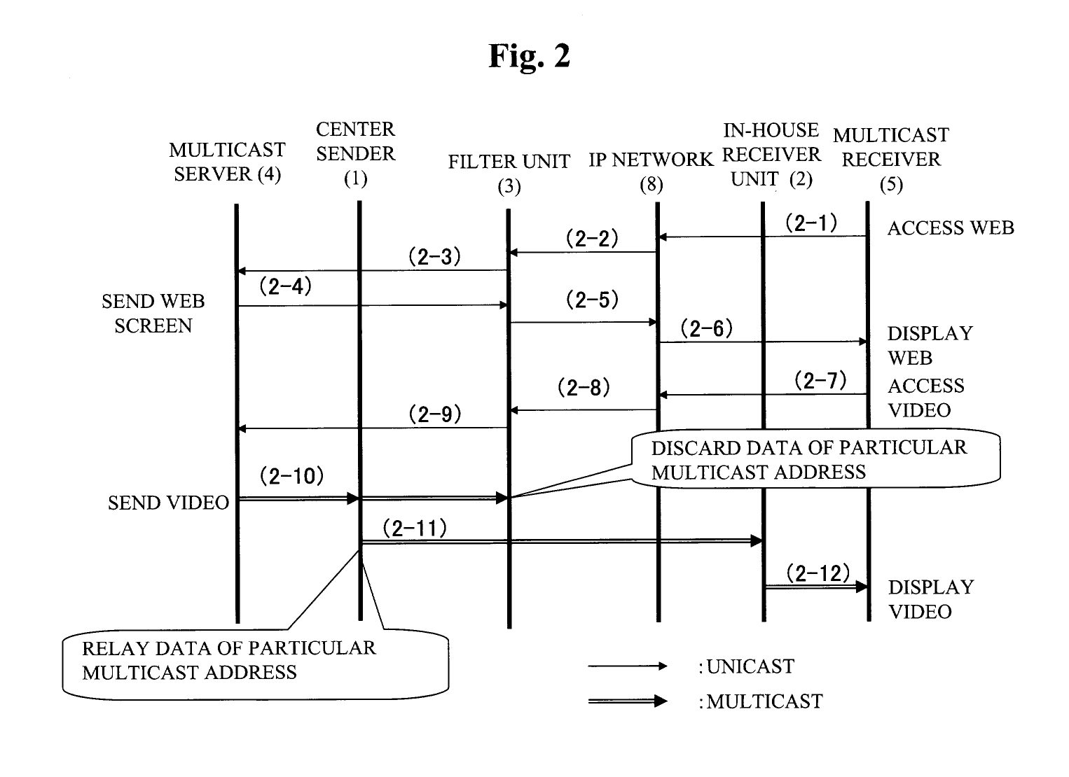

Next, a description will be given of the operation of the system shown in FIG. 1 with reference to FIG. 2.

For the sake of simplicity in description, the following assumes that the multicast server 4 supports even portal sites (Web screens). Alternatively, another server connected to the center LAN 6 or a server on the IP network 8 may support the portal sites. Usually, a protocol of unicast is used when the multicast receiver terminal 5 accesses a portal site using the navigator such as IE (Internet Explore) or the like. Thus, a sequence (route) of (2-1), (2-2) and (2-3) shown in FIG. 2 is used as a down link, and a sequence (route) of (2-4), (2-5) and (2-6) is used as an up link. In this case, the filter unit 3 is involved in only relaying.

The multicast receiver terminal 5 accesses multicast data such as video referred to from the portal side as follows. In this case, the request for access is unicast. Therefore, a sequence (route) of (2-7), (2-8) and (2-9) is used as the down link. The multicast data is sent by the multicast server 4 as multicast data (2-10). Then, the multicast data (2-10) is received by both the center sender 1 and the filter unit 3.

A particular multicast address has been registered with the center sender 1. If the multicast address of the multicast data (2-10) coincides with the particular multicast address (or one of the multicast addresses) registered with the center sender 1, the center sender 1 performs a relay operation on the transmission network 9 (to which the in-house receiver unit 2 is connected), and sends the multicast data (2-11) to the transmission network 9. The same multicast address has been registered with the filter unit 3. Since the multicast address of the multicast data (2-10) coincides with the particular multicast address registered with the filter unit 3, the unit 3 discards the multicast data and does not perform the relay operation.

Upon receiving multicast data (2-11) via the transmission network 9, the in-house receiver unit 2 relays it to the multicast receiver terminal 5 as multicast data (2-12).

The center sender 1 and the filter unit 3 defines a bypass network including the transmission network 9 between the center LAN 6 and the subscriber LAN 7 over which multicast data of a particular multicast address can be transferred so as to bypass the IP network 8. With the above structure, it is possible to realize advanced broadband multicast system.

### First Embodiment

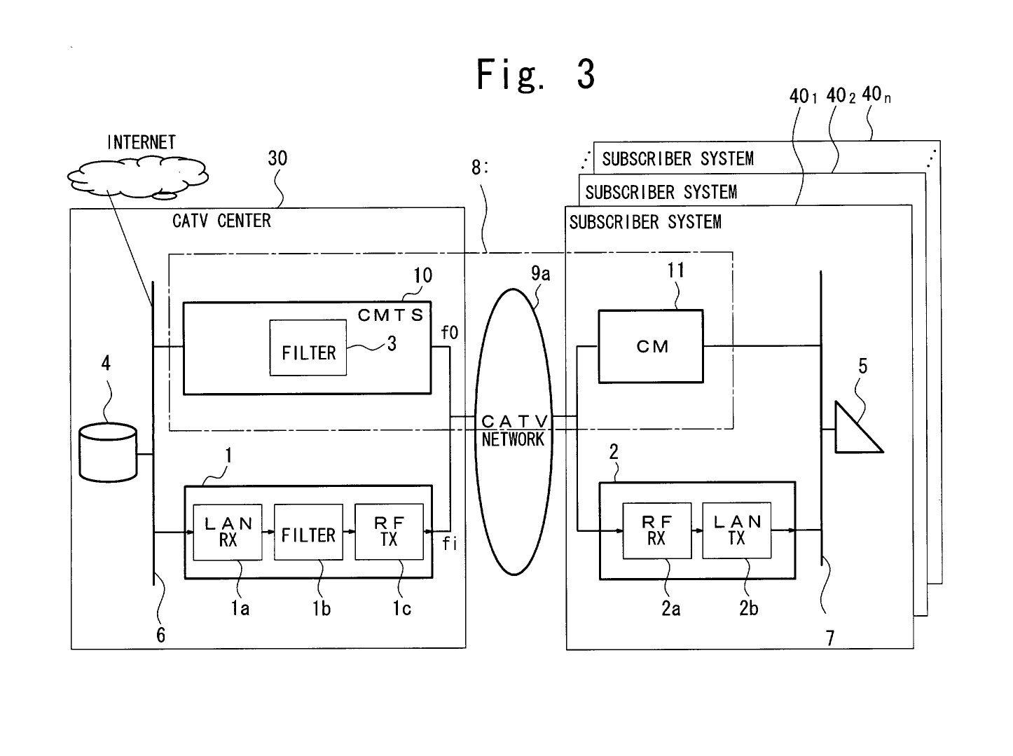

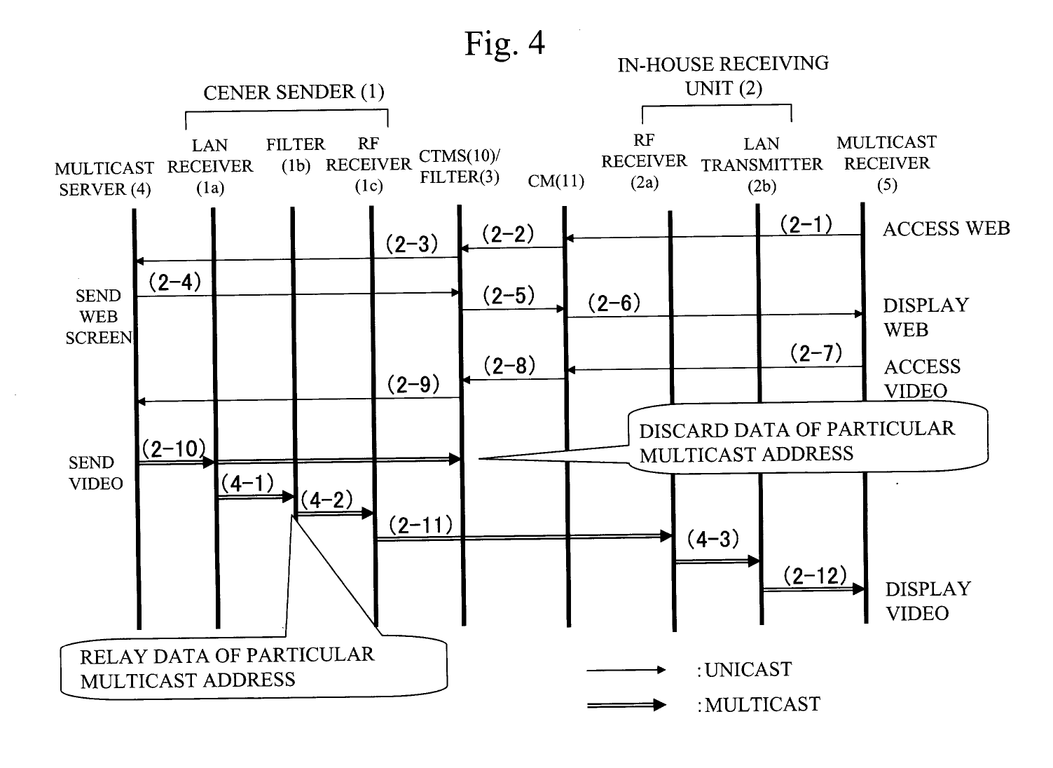

A description will now be given of a first embodiment of the present invention with reference to FIGS. 3 and 4. FIG. 3 shows the configuration of a system according to the first embodiment of the present invention, and FIG. 4 is a sequence diagram of the operation thereof.

Referring to FIG. 3, a CATV center 30 and subscriber systems 40₁, 40₂, . . . , 40ₙ are connected by a CATV transmission network 9a and the IP network 8 with a cable modem system (ITU J. 112 Annex B specification) using the CATV transmission network 9a, which may, for example, be a CATV transmission line.

The CATV center 30 includes the center sender 1, which is a communication apparatus, a CMTS (Cable Modem Termination System) 10, and the multicast server 4. The CMTS 10 is a center apparatus of the cable modem system. The filter unit 3 is implemented as an internal function of the CMTS 10. The center sender 1 is interposed between the center LAN 6 (to which the multicast server 4 capable of sending multicast data and the Internet are connected) and the CATV transmission network 9a, and is connected thereto. The center sender 1 is made up of a LAN receiver 1a, a filter 1b and an RF transmitter 1c. The LAN receiver 1a has the function of terminating the center LAN 6. The filter 1b has the function of relaying multicast data specified by the particular multicast address. The RF transmitter 1c has the function of terminating the CATV transmission network 9a. The CMTS 10 is provided between the center LAN 6 and the CATV transmission network 9a.

Each of the subscriber systems 40₁ through 40ₙ is composed of the in-house receiver unit 2, CM (Cable Modem) 11 that is an in-house-use version of the cable modem system, and the multicast receiver terminal 5.

The CM 11 connected to the CATV transmission network 9a and the multicast receiver terminal 5 are connected via the subscriber LAN 7. The in-house receiver unit 2, which is a communication apparatus, is interposed between the subscriber LAN 7 and the CATV transmission network 9a. The multicast receiver terminal 5 has a Web navigating function in addition to the function of receiving multicast data, although the navigation function is not essential. The in-house receiver unit 2 is composed of an RF receiver 2a and a LAN transmitter 2b. The RF receiver 2a has the function of terminating the CATV transmission network 9a. The LAN transmitter 2b has the function of terminating the subscriber LAN 7.

For a transmission network that can be shared by plural subscribers, such as the CATV transmission network 9a, a plurality of in-house receiver units 2 can be connected to the transmission network for the single center sender 1.

The operation of the system shown in FIG. 3 is described with reference to FIG. 4.

As in the case shown in FIG. 2, it is assumed that the multicast server 4 supports portal sites (Web screens). Usually, the protocol of unicast is used when the multicast receiver terminal 5 accesses a portal site using the navigator such as IE (Internet Explore) or the like. Thus, a sequence (route) of (2-1), (2-2) and (2-3) shown in FIG. 4 is used as a down link, and a sequence (route) of (2-4), (2-5) and (2-6) is used as an up link. In this case, the filter unit 3 in the CMTS 10 is involved in only relaying.

The multicast receiver terminal 5 accesses multicast data such as video referred to from the portal side as follows. In this case, the request for access is unicast. Therefore, a sequence (route) of (2-7), (2-8) and (2-9) is used as the down link. The multicast data received is sent by the multicast server 4 as multicast data (2-10). Then, the multicast data (2-10) is received by both the LAN receiver 1a of the center sender 1 and the CMTS 10.

In the center sender 1, multicast data (2-10) is relayed to the filter 1b from the LAN receiver la as multicast data (4-1). A particular multicast address has been registered with the filter 1b. If the multicast address of multicast data (4-1)(the same as multicast data (2-10)) coincides with the registered multicast address or one of the multicast addresses, data is relayed from the filter 1b to the RF transmitter 1c, so that resultant multicast data (2-11) is sent to the CATV transmission network 9a (to which the in-house receiver unit 2 is connected). The same multicast addresses as the above-mentioned registered multicast addresses have been registered with the filter 3 in the CMTS 10. In the sequence being considered, the multicast address of multicast data (2-10) coincides with one of the registered multicast addresses. Thus, the filter 3 discards the multicast data and does not perform the relay operation.

Upon receiving the multicast data (2-11) from the CATV transmission network 9a, the in-house receiver unit 2 relays the received data from the RF receiver 2a to the LAN transmitter 2b (4-3), and sends it to the multicast receiver terminal 5 as multicast data (2-12).

As described above, between the center LAN 6 and the subscriber LAN 7, there is provided the bypass network with which the IP network 8 is bypassed in transmission of multicast data specified by the particular multicast address. With the above structure, it is possible to achieve the broadband IP multicast system that is not affected by the transmission band of the IP network 8. Further, the IP multicast system can be constructed even when the conventional IP network does not support multicast.

### Second Embodiment

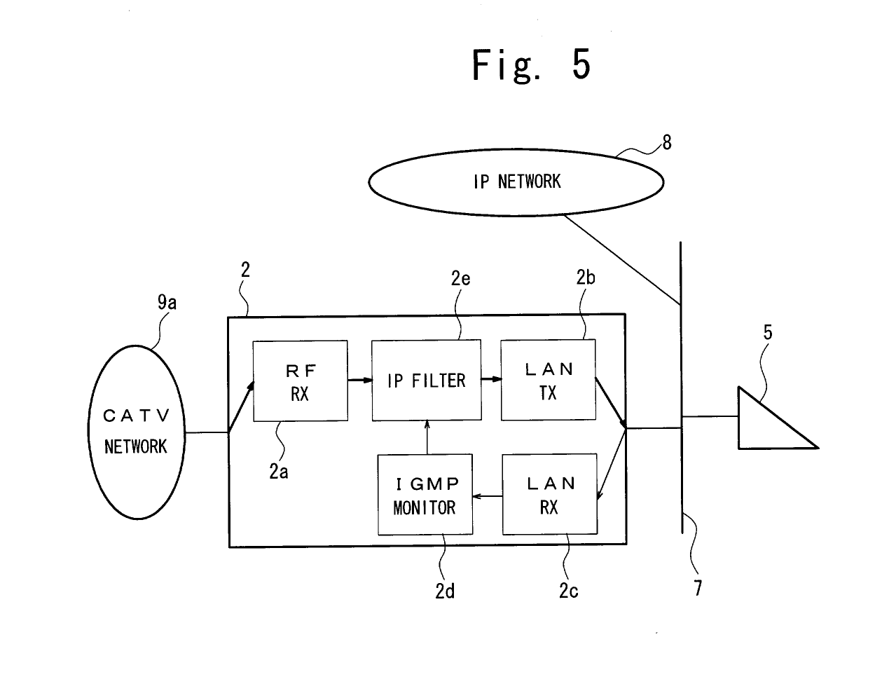

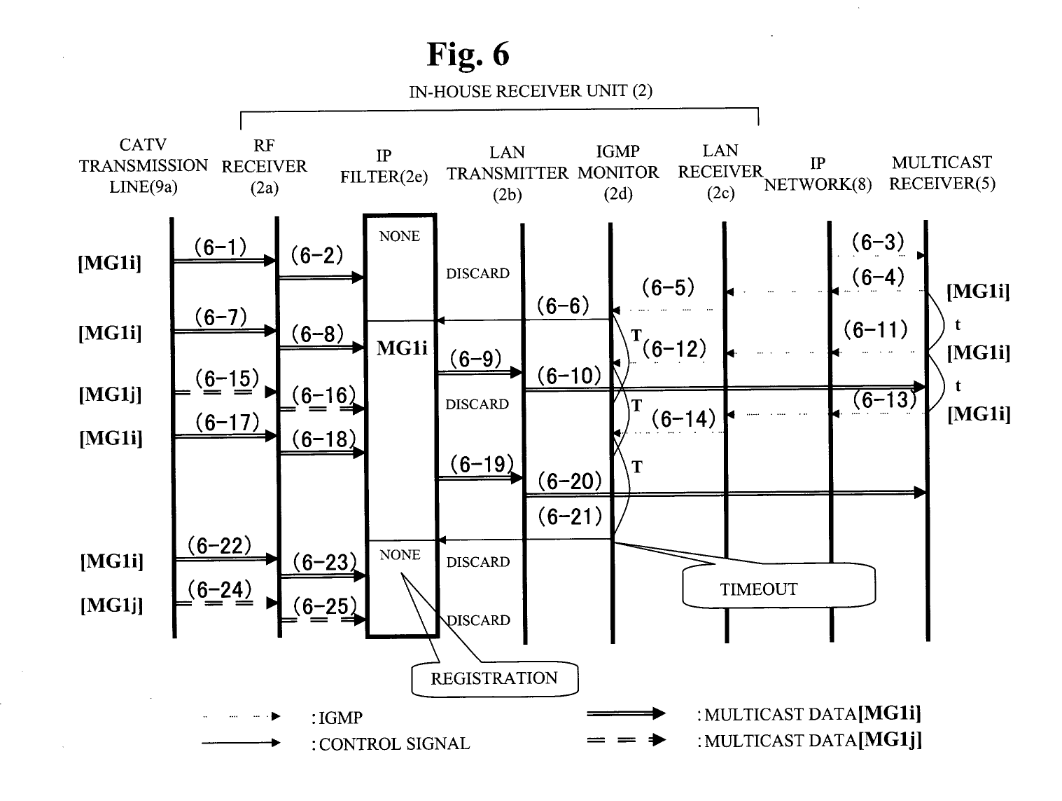

FIGS. 5 and 6 respectively illustrate a system configuration and its operating sequence according to a second embodiment of the present invention.

The present embodiment employs IGMP (Internet Group Management Protocol: RF1112) as group management protocol for multicast. In FIG. 5, the in-house receiver system 2 is equipped with the in-house receiver unit 2, the multicast receiver terminal 5, CM (which is omitted for the sake of simplicity although it is provided as in the case shown in FIG. 3), and the subscriber LAN 7 connecting the above structural elements together.

The in-house receiver unit 2 is made up of an RF receiver 2a, an IP filter 2e, a LAN transmitter 2b, a LAN receiver 2c and an IGMP monitor 2d. The RF receiver 2a is equipped with the function of terminating the CATV transmission network 9a. The IP filter 2e controls data sending so as to block multicast data having the particular multicast address. The LAN transmitter 2b sends multicast data to the subscriber LAN 7. The LAN receiver 2c receives IGMP from the subscriber LAN 7. The IGMP monitor 2d analyzes information on IGMP, and notifies the IP filter 2e of the multicast address of multicast data that is to be relayed. The multicast receiver terminal 5 has the IGMP function in addition to the multicast data receiving function.

The operation of the system shown in FIG. 5 is described with reference to FIG. 6.

In IGMP, a general query is periodically sent to the network by a router connected thereto in order to show that multicast is supported. The present embodiment is configured so that the IP network 8 sends IGMP[General Query](6-3). If the IP network 8 does not support multicast, the in-house receiver unit 2 may send out IGMP[General Query](6-3).

Upon receiving IGMP[General Query], the multicast receiver terminal 5 sends the IP network 8 IGMP[Membership Report](6-4) including multicast address [MG1i] that the terminal 5 wants to receive. Further, the multicast receiver terminal 5 sends the IP network 8 IGMP[Membership Report](6-11) and (6-13) having the same content again at a timer interval t during the period when the multicast receiver terminal 5 wants to receive multicast data having the desired multicast address. The LAN receiver 2c receives IGMP[Membership Report](6-4), and relays it to the IGMP monitor 2d. Then, the IGMP monitor 2d extracts the multicast address from the received data, and instructs the IP filter 2e to record the multicast address [MG1i](6-6), while simultaneously activating a timer T (t<T).

When the IGMP monitor 2d receives IGMP[Membership Report](6-12) or (6-14) having the same multicast address as that stored while the timer T is being activated, the monitor 2d reactivates only the timer T. Although not illustrated in FIG. 6, when the IGMP monitor 2d receives IGMP[Membership Report] having a different multicast address, the monitor 2d instructs the IP filter 2e to record the above different multicast address and simultaneously activates another timer T different from the aforementioned timer T. When the individual timers T time out, the IGMP monitor 2d instructs the IP filter 2e to delete the multicast address [MG1i] (6-21).

The RF receiver 2a receives the multicast data [MG1i](6-1) and (6-7), and relays the data to the IP filter 2e ((6-2) and (6-8)). When the multicast address of the multicast data [MG1i] (MG1i in the case being considered) is not in the registered status as the filtering condition specified by the IGMP monitor 2d, the IP filter 2e discards multicast data [MG1i](6-2). In contrast, when the multicast address of the multicast data [MG1i] is in the registered status, the IP filter 2e relays the multicast data [MG1i](6-8) to the LAN transmitter 2b, so that multicast data (6-10) can finally be received by the multicast receiver terminal 5.

As to multicast data (6-15), (6-17), (6-22) and (6-24), multicast data (6-16), (6-23) and (6-25) are discarded by the above-mentioned operation, while multicast data (6-20) is received by the multicast receiver terminal 5.

As described above, according to the second embodiment of the present invention, the in-house receiver unit 2 has the function of receiving and sending the group management protocol that conforms to multicast from and to the subscriber LAN 7, and controls sending LAN data to the subscriber LAN 7 (more particularly, controls to start and stop sending LAN data) in accordance with information in the group management protocol. In the above-mentioned manner, traffic of sending to the subscriber LAN 7 is limited (filtered) to only the multicast address requested by the subscriber. It is therefore possible to expand the transmission band of the bypass relay network (at a single wave) without restriction on the transmission band of the subscriber LAN 7.

The second embodiment of the present invention includes a system configuration in which two or more subscribers are connected to the CATV transmission network 9a as in the case shown in FIG. 3.

Third Embodiment

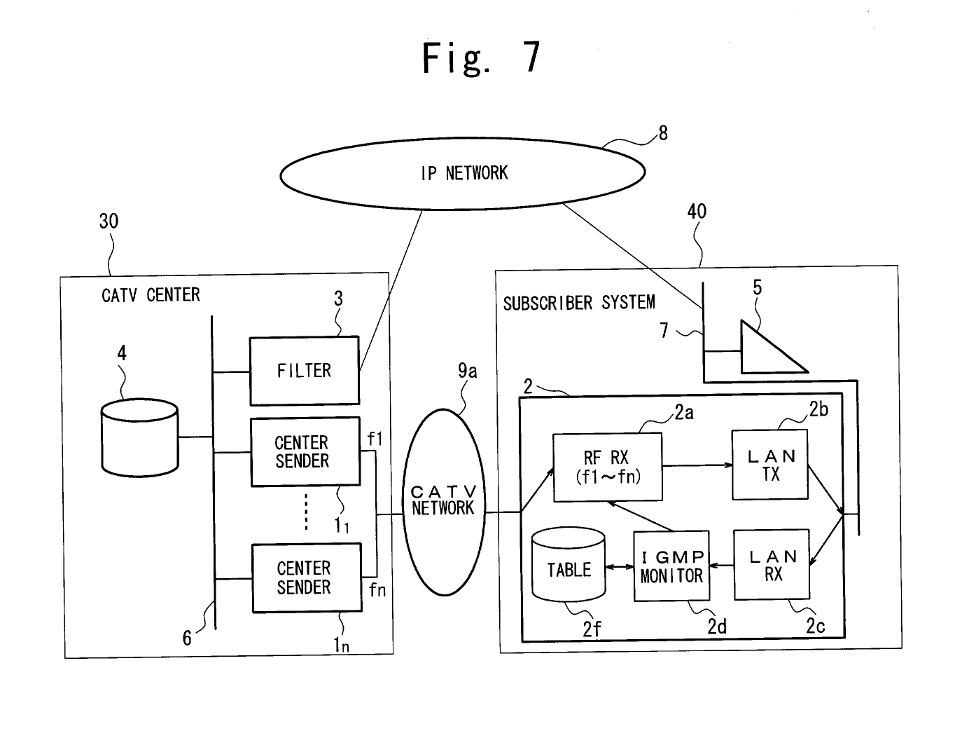

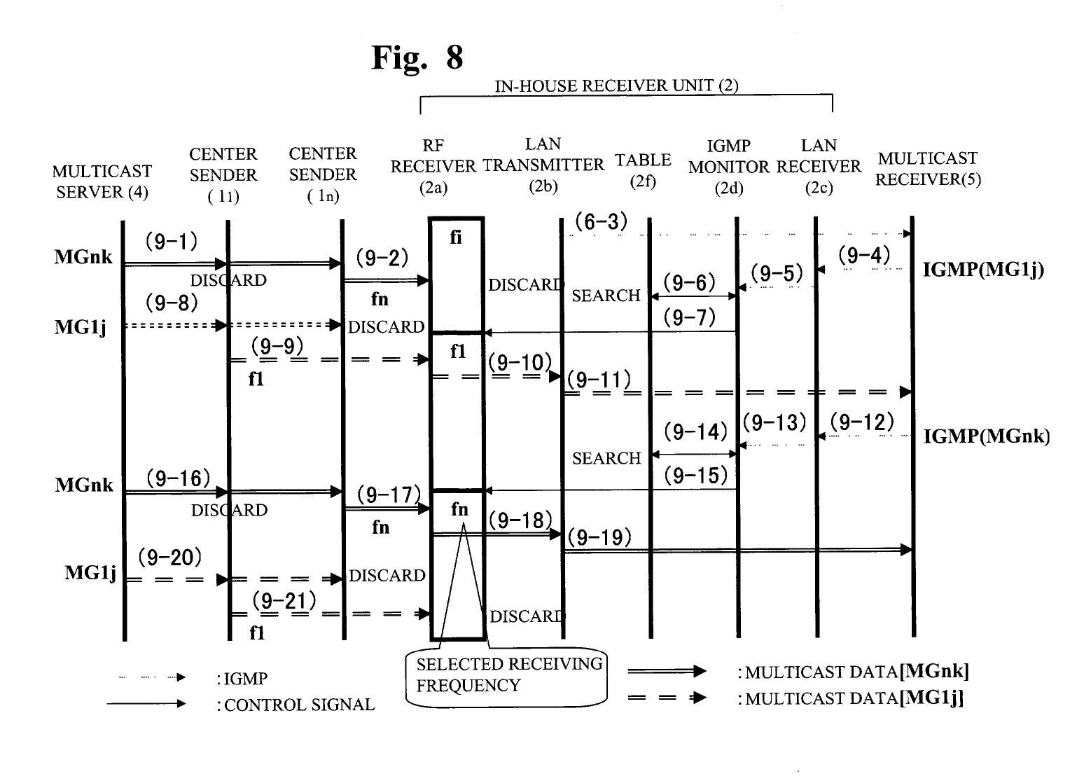

FIG. 7 illustrates a system configuration of the third embodiment of the invention, and FIG. 8 is a sequence of the operation thereof. The present embodiment employs IGMP (RFC1112) as group management protocol for multicast.

Referring to FIG. 7, the CATV center 30 and the subscriber system 40 are connected by the IP network 8 and the CATV transmission network 9a. The CATV center 30 has a plurality of center senders 1₁ through 1ₙ, the filter unit 3 and the multicast server 4. The center senders 11 through in are connected between the center LAN 6 and the CATV transmission network 9a. The multicast server 4, which is connected to the center LAN 6, sends multicast data thereto. The filter unit 3 is connected between the center LAN 6 and the IP network 8. The center senders 1₁ through in receive and relay multicast data of respective particular multicast addresses different from one another, and sends the respective multicast data to the CATV transmission network 9a at respective different frequencies. More particularly, the center sender 1₁ receives and relays multicast data having multicast addresses MG11˜MG1p, and sends these items of multicast data to the CATV transmission network 9a at a frequency f₁. Similarly, the center sender 1ₙ receives and relays multicast data having multicast addresses MGn1˜MGnq, and sends these items of multicast data to the CATV transmission network 9a at a frequency fₙ.

The subscriber system 40 is equipped with the in-house receiver unit 2, the multicast receiver terminal 5, CM connected to the IP network (CM is not illustrated for the sake of simplicity, although it is provided as shown in FIG. 3), and the subscriber LAN 7.

The in-house receiver unit 2 is made up of the RF receiver 2a, which is a tunable receiver, the LAN transmitter 2b, the LAN receiver 2c, IGMP monitor 2d, and a table 2f. The RF receiver 2a has the function of terminating the CATV transmission network 9a. The LAN transmitter 2b sends out multicast data to the subscriber LAN 7. The LAN receiver 2c receives IGMP from the subscriber LAN 7. The IGMP monitor 2d searches the table 2f for the receiving frequency corresponding to the multicast address extracted from IGMP, and instructs the RF receiver 2a to be tuned at the above receiving frequency. The table 2f defines the relationship between the multicast address and the receiving frequency. The table 2f is developed on a memory means such as a memory or a hard disc drive.

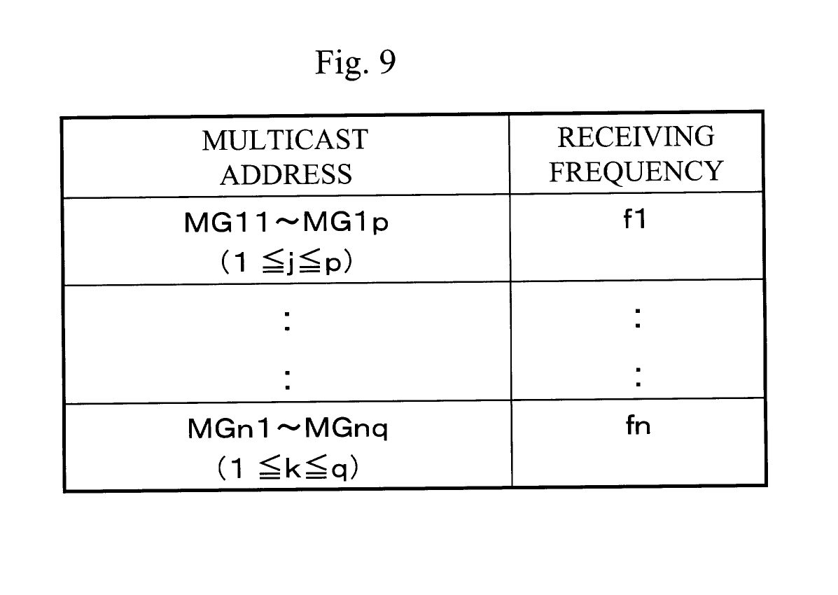

FIG. 9 shows a configuration of the table 2f. The table 2f describes the relationship between the multicast address and the receiving frequency. For example, multicast addresses MG1j (1≦j≦p) are assigned receiving frequency f₁, and multicast addresses MGnk (1≦k≦q) are assigned receiving frequency fₙ.

The multicast receiver terminal 5 has the function of IGMP in addition to the function of receiving multicast data.

The operation of the system shown in FIG. 7 is described with reference to FIG. 8.

In IGMP, a general query is periodically sent by a router connected to a network in order to show the network that multicast is supported. In the present embodiment, the LAN transmitter 2b sends IGMP[General Query] (6-3) to the network. Alternatively, if the IP network 8 supports multicast, the IP network 8 may send IGMP[General Query](6-3).

Upon receiving IGMP[General Query](6-3), the multicast receiver terminal 5 sends IGMP[Membership Report](9-4) including multicast address [MG1j] which the terminal 5 wants to receive. Although not illustrated in FIG. 8 for the sake of simplicity, the multicast receiver terminal 5 sends the IP network 8 IGMP[Membership Report](9-4) having the same content again at a timer interval t during the period when the multicast receiver terminal 5 wants to receive multicast data having the desired multicast address. The LAN receiver 2c receives IGMP[Membership Report](9-4), and relays it to the IGMP monitor 2d (9-5). Then, the IGMP monitor 2d extracts the multicast address from the received data, and looks up the table 2f (FIG. 9) in order to search for the receiving frequency f, associated with the multicast address [MG1j] (9-6). Then, the IGMP monitor 2d instructs the RF receiver 2a to change the receiving frequency to f₁ (9-7).

Similarly, the multicast receiver terminal 5 that wants to receive multicast data of multicast address [MGnk] sends IGMP[Membership Report] including multicast address [MGnk]. Although not illustrated in FIG. 8, the multicast receiver terminal 5 sends the IP network 8 IGMP[Membership Report](9-12) having the same content again at a timer interval t during the period when the multicast receiver terminal 5 wants to receive multicast data having the desired multicast address. The LAN receiver 2c receives IGMP[Membership Report](9-12), and relays it to the IGMP monitor 2d (9-13). Then, the IGMP monitor 2d extracts the multicast address from the received data, and looks up the table 2f (FIG. 9) in order to search for the receiving frequency fₙ associated with the multicast address [MGnk] (9-14). Then, the IGMP monitor 2d instructs the RF receiver 2a to change the receiving frequency to fₙ (9-15).

Multicast data [MGnk](9-1) sent by the multicast server 4 is received by all of the center senders 1₁ through 1ₙ. However, the multicast data [MGnk] is relayed by only the center sender 1ₙ with which the multicast address of the multicast data [MGnk] has been registered, and is then received, at the frequency fₙ, by the RF receiver 2a in the in-house receiver unit 2 via the CATV transmission network 9a. However, since the receiving frequency f₁ is set at the RF receiver 2a, multicast data (9-2) is discarded.

Similarly, multicast data [MG1j](9-8) sent by the multicast server 4 is received by all the center senders 1₁ through 1ₙ. However, the multicast data [MG1j] is relayed by only the center sender 1₁ with which the multicast address thereof has been registered, and is then received, at the frequency f₁, by the RF receiver 2a in the in-house receiver unit 2 via the CATV transmission network 9a. Since the receiving frequency f₁ is set at the RF receiver 2a, multicast data (9-9) is received and relayed by the RF receiver 2a (9-10), and is sent from the LAN transmitter 2b to the multicast receiver terminal 5 as multicast data (9-11).

In the same manner as described above, multicast data (9-16) reaches the multicast receiver terminal 5, while multicast data (9-20) is discarded.

As described above, the CATV center 30 shown in FIG. 7 includes the plurality of center senders 1₁ through 1ₙ, which receive multicast data of the respective particular multicast addresses different from one another and send the multicast data at the respective different frequencies. The subscriber system 40 has the function of receiving and sending the group management protocol for multicast from and to the subscriber LAN 7, and the table 2f that describes the relationship between the multicast addresses and the receiving frequencies (identical to the sending frequencies of the center senders 1₁ through 1ₙ). The multicast address is extracted from information in the group management protocol, and the receiving frequency that corresponds to the multicast address thus extracted is retrieved from the table 2f. Then, the multicast data is received at the selected frequency. Thus, the bypass relay network can be expanded to a plurality of carrier waves or frequencies (n), so that the transmission band can be expanded n times.

The system shown in FIG. 7 may be varied so that a plurality of subscriber systems is connected to the CATV transmission network 9a.

Fourth Embodiment

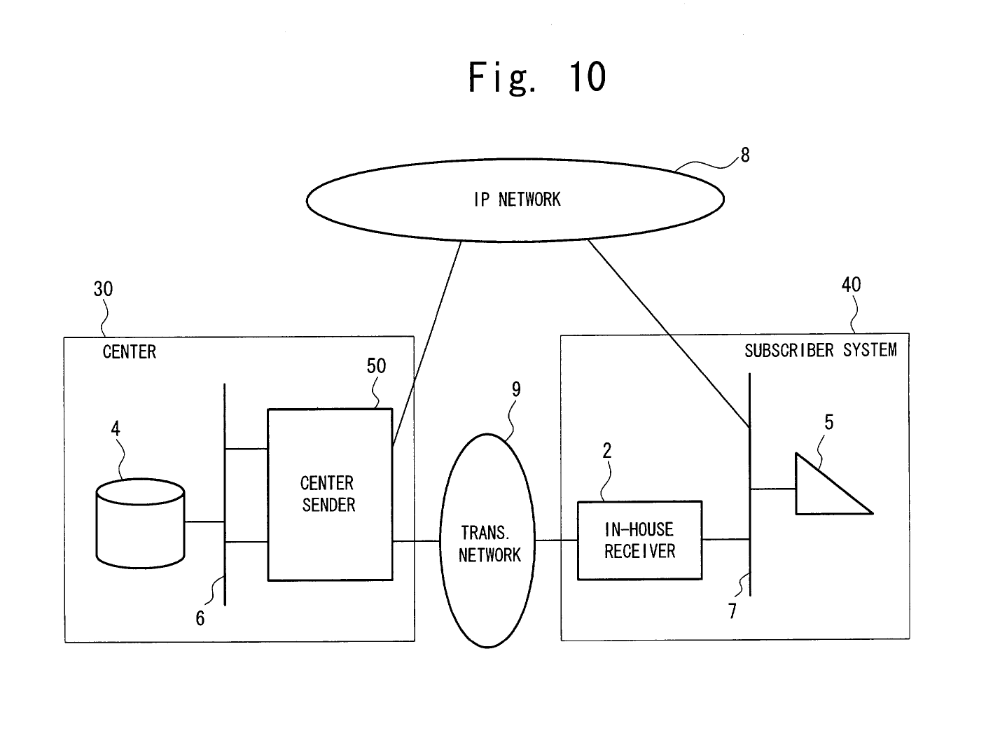

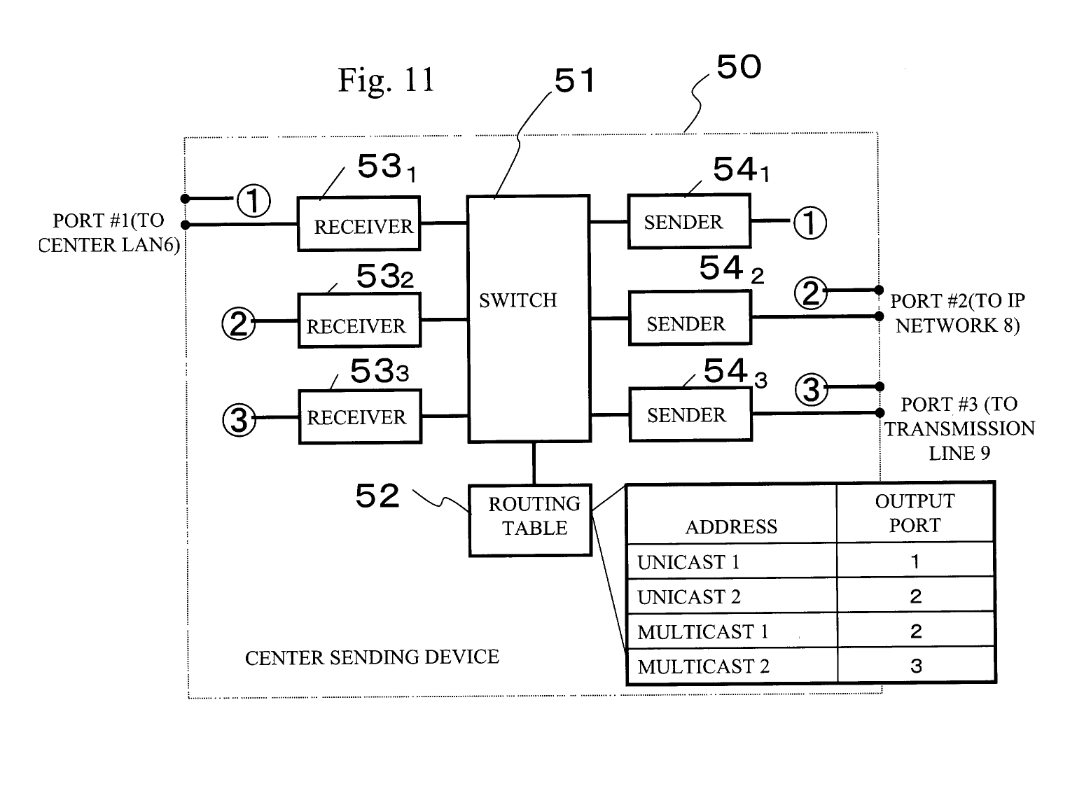

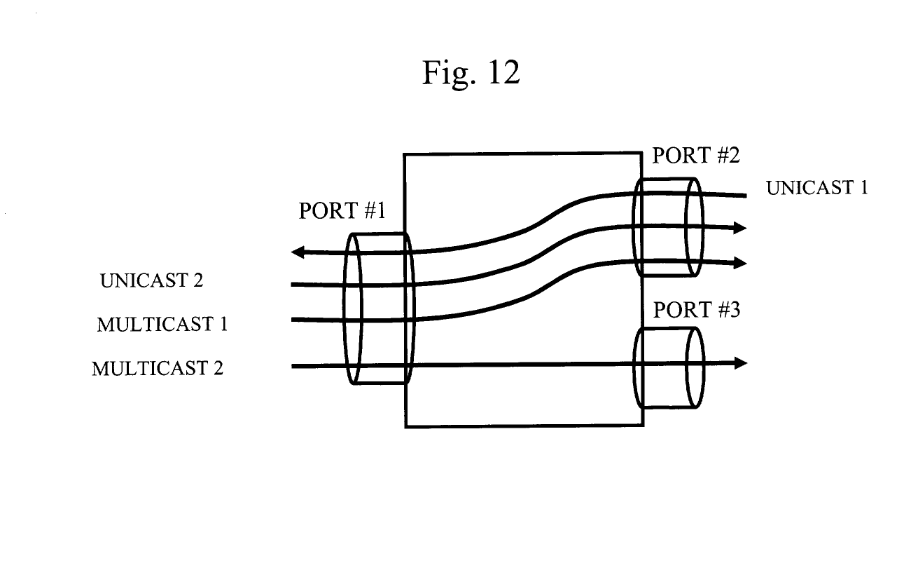

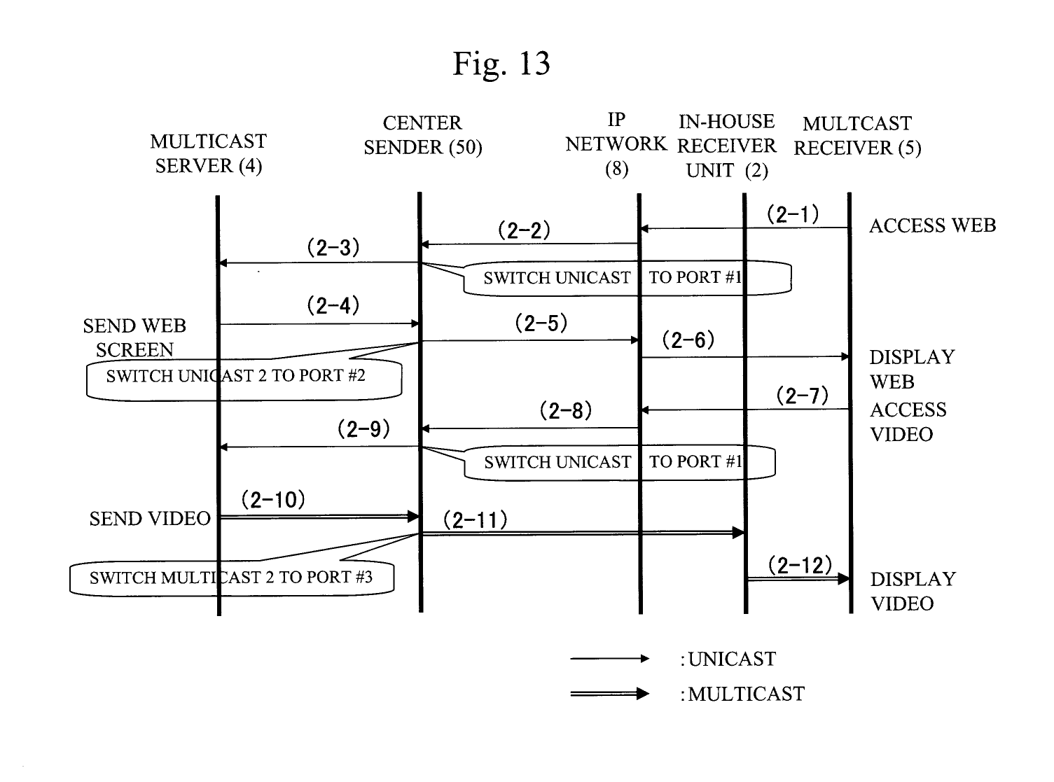

FIG. 10 illustrates a system configuration according to a fourth embodiment of the present invention. FIG. 11 shows an internal structure of a center sender 50 shown in FIG. 10. Further, FIG. 12 shows a function of the center sender 50, and FIG. 13 shows a sequence of the operation of the system.

The system shown in FIG. 1 employs the center sender 1 and the filter unit 3 for making the bypass transmission system, whereas the system shown in FIG. 10 employs the center sender 50 that has a routing function (switching function). The routing function sends multicast data having a particular multicast address to only the transmission network 9 and prevents it from being sent to the IP network 8.

The center sender 50 is provided between the center LAN 6 and the transmission network 9. As shown in FIG. 11, the center sender 50 includes a switch 51, a routing table 52 developed on a memory in the center sender 50, receiving parts 531 through 533, and sending parts 541 through 543. The switch 51 switches data between the center LAN 6 and the IP network 8 and between the center LAN 6 and the transmission network 9. The multicast server 4 is connected to the center LAN 6. The routing table 52 stores routing information that defines the switching operation of the switch 51. The switch 51 is connected to ports #1-#3 via the receiving parts 53₁-53₃ and the sending parts 54₁-54₃. Port #1 is connected to the center LAN 6, and port #2 is connected to the IP network 8. Port #3 is connected to the transmission network 9. As shown in FIG. 11, the routing table 52 stores routing information that defines the connection between the addresses and the output ports for unicast and multicast. The routing table 52 shown in FIG. 11 exemplarily shows some items of routing information. FIG. 12 shows routing that reflects the exemplary routing information shown in FIG. 11. In FIG. 12, “multicast 2” is multicast data having the particular multicast address, and is sent to the transmission network 9 via port #3.

FIG. 13 shows an operation sequence using the routing information shown in FIGS. 11 and 12. In the sequence shown in FIG. 13, the function implemented by the center sender 1 and the filter unit 3 shown in FIG. 1 is realized by the routing function of the center sender 50.

For the sake of simplicity in the following description, it is now assumed that the portal site (Web screen) is supported by the multicast server 4. However, another server connected to the center LAN 6 or a server on the IP network 8 may support the portal site. Usually, a protocol of unicast is used when the multicast receiver terminal 5 accesses a portal site using the navigator such as IE (Internet Explore) or the like. Thus, a sequence (route) of (2-1), (2-2) and (2-3) shown in FIG. 13 is used as a down link, and a sequence (route) of (2-4), (2-5) and (2-6) is used as an up link. In this case, the center sender 50 connects unicast 1 to port #1 by routing, and unicast 2 to port #2 by routing. The above routing is carried out so that the switch 51 refers to the routing table 52.

When the multicast receiver terminal 5 accesses multicast data such as video referred to from the portal side, the request for access is unicast. Therefore, a sequence (route) of (2-7), (2-8) and (2-9) is used as the down link. The center sender 50 routes the received unicast 1 to port #1. Multicast 2 is sent by the multicast server 4 as multicast data (2-10). The center sender 50 routes multicast data (2-10) to port #3, and does not route it to port 2 to which the IP network 8 is connected. The in-house receiver unit 2 that receives multicast data (2-11) via the transmission network 9 sends out it to the multicast receiver terminal 5 as multicast data (2-12).

As is described above, the system has the switch 51 that switches data between the center LAN 6 and the IP network 8 and between the center LAN 6 and the transmission network 9, and the routing table 52 that stores routing information that defines the routing operation of the switch 51. The routing information is so defined that multicast data having the particular multicast address (multicast 2 in the above example) is prevented from being sent to the IP network 8. Thereby, a network that bypasses the IP network 8 can be defined between the center LAN 6 and the subscriber LAN 7 for transmission of multicast data. Thus, the advanced broadband multicast system can be constructed.

Fifth Embodiment

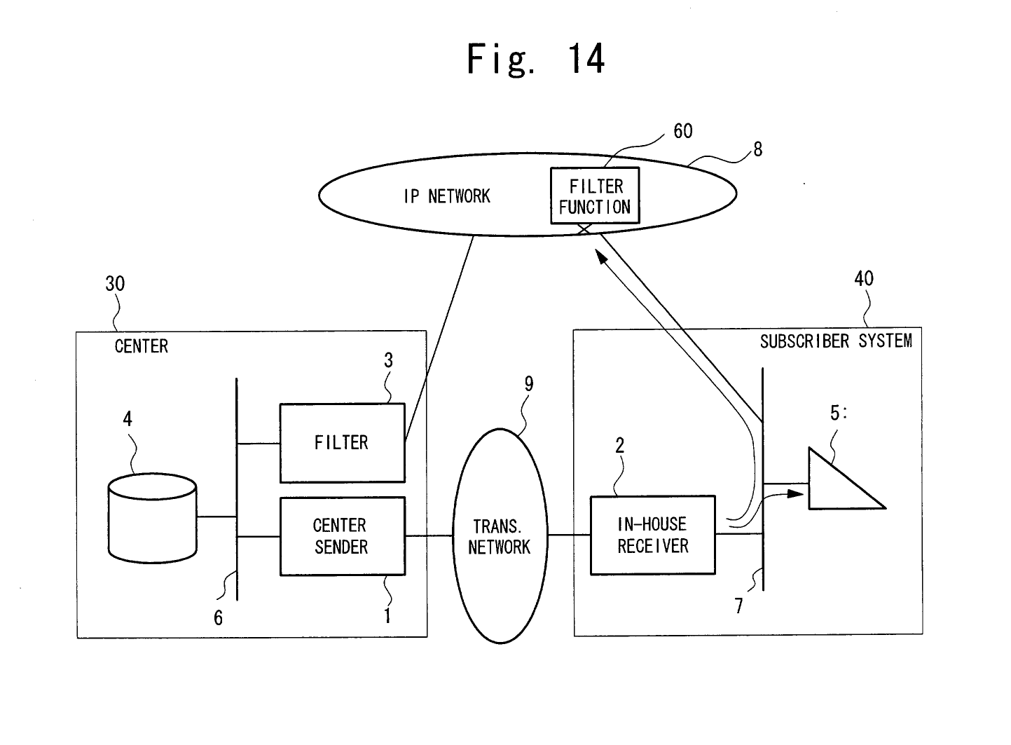

FIG. 14 illustrates a system configuration according to a fifth embodiment of the present invention.

The system is equipped with a filter function unit 60, which prevents multicast data having the particular multicast address from being forwarded to the IP network 8. The filter function unit 60 prevents, at an inlet of the IP network 8, multicast data having the particular multicast address from flowing therein. The preventing function of the filter function unit 60 may easily be realized by, for example, the IP filter function of the CM 11 shown in FIG. 3. The IP filter function of CM 11 discards the target multicast data.

The filter function unit 60 may be applied to the embodiments of the invention shown in FIGS. 5, 7 and 10 as well.

Sixth Embodiment

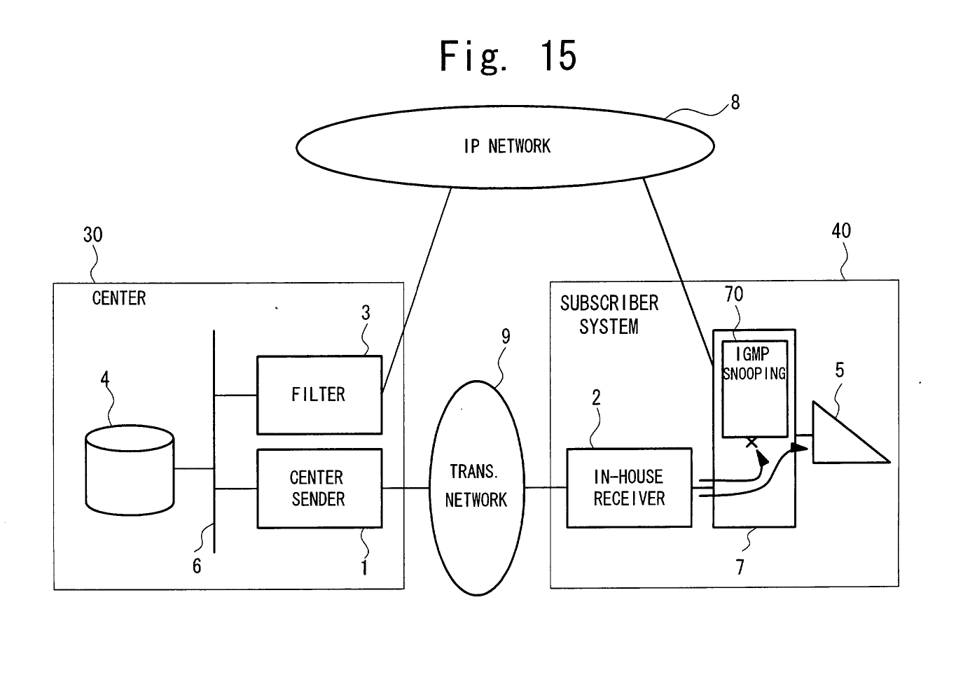

FIG. 15 illustrates a system configuration according to a sixth embodiment of the present invention.

The subscriber LAN 7 is equipped with the function of preventing multicast data from being forwarded to the IP network 8 from the subscriber system 40. This function may be implemented by equipping the subscriber LAN 7 with an IGMP snooping function 70. The IGMP snooping function has been described previously. IGMP[Membership Report] of the particular multicast address is not sent from the IP network 8. Thus, multicast data of the corresponding multicast address is not switched to the IP network 8 due to the IGMP snooping function 70.

Seventh Embodiment

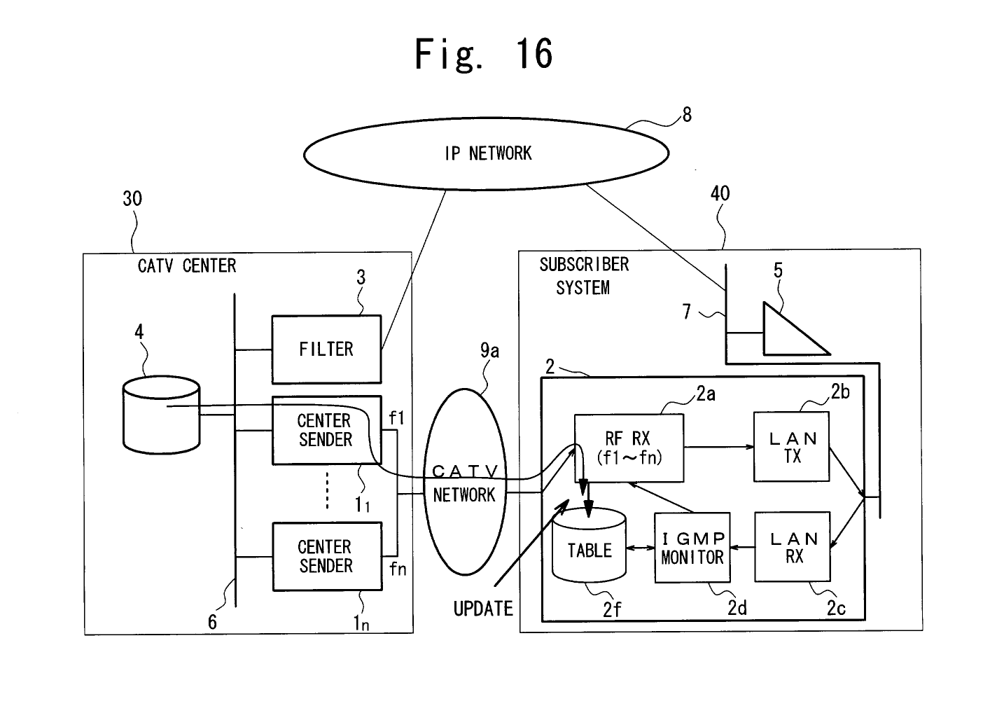

FIG. 16 shows a system configuration according to a seventh embodiment of the present invention.

In this embodiment, the table 2f may be accessed from the CATV center 30 via the CATV transmission network 9a, so that the content of the table 2f can be updated. Data having a particular multicast address for updating is sent to the table 2f via the transmission network 9. With this structure, the multicast address and the receiving frequencies described in the table 2f can easily be updated. FIG. 16 shows an exemplary case where the center sender 1₁ sends data having the particular multicast address for updating and the table 2f in each of the in-house receiver units 2 is updated. Similarly, the center senders 12 through I, update the corresponding tables 2f. The table 2f may be accessed and updated via the IP network 8.

The seventh embodiment of the present invention may be applied to the other embodiments thereof. For example, the seventh embodiment may be applied to the center sender 50 shown in FIG. 11 that prevents multicast data having the particular multicast address from being forwarded to the IP network 8.

The present invention is not limited to the CATV transmission network but may be applied to a network in which plural subscribers share a transmission network, which may be ATM-PON or Ethernet PON. The subscribers can simultaneously receive the same multicast data (for example, the same program) by simply sending it to the IP multicast relay system only once.

Finally, several aspects of the present invention are summarized below. In the following, numeral numbers are given elements with parentheses for reference, but the elements are not limited to those assigned the numeral numbers.

According to an aspect of the present invention, there is provided IP multicast relay system comprising: a center (30) and subscriber systems (40) connected thereto via both an IP network (8) and a transmission network (9, 9a); a center sender (1) provided in the center, the center sender receiving multicast data having a particular multicast address via a center LAN (6) to which a multicast server (4) that sends multicast data to the center LAN is connected and relaying the multicast data thus received to the transmission network; a filter unit (3) that is connected between the center LAN and the IP network and prevents the multicast data having the particular multicast address from being sent to the IP network; and a receiver unit (2) provided in the subscriber system, the receiver unit receiving the multicast data via the transmission network and sending the multicast data thus received to a subscriber LAN (7) to which the IP network (8) and a multicast receiver terminal (5) are connected.

The IP multicast relay system may be configured so that the receiver unit comprises means (2d, 2e) for receiving and sending group management protocol for multicast from and to the subscriber LAN and controlling sending of data to the subscriber LAN in accordance with information contained in the group management protocol.

The IP multicast relay system may be configured so that: the center includes center senders (1₁˜1ₙ; FIG. 7) that accept multicast data of respective particular multicast addresses different from one another and send multicast data to the transmission network at respective different frequencies (f₁˜fₙ); the receiver unit includes means (2a, 2d) for receiving and sending group management protocol for multicast from and to the subscriber LAN and a table (2f) that defines a relationship between multicast addresses and receiving frequencies on the transmission network; and the receiver unit extracts the multicast address from information contained in the group management protocol, and searches the table for one of the receiving frequencies corresponding to the multicast address thus extracted, the receiver unit receiving the multicast data at said one of the receiving frequencies. With this structure, the transmission band can be expanded n times.

The IP multicast relay system may be configured so that it further includes a part (60) that is provided in the IP network and prevents data having the particular multicast address from flowing in the IP network. This makes it impossible for multicast data transmitted over the transmission network to be forwarded to the IP network.

Alternatively, the IP multicast relay system may be configured so that it further includes a part (70) that is provided in the subscriber LAN and prevents data having the particular multicast address from being forwarded to the IP network. This makes it impossible for multicast data transmitted over the transmission network to flow in the IP network.

According to another aspect of the present invention, there is provided a communication apparatus (30) connectable to both an IP network (8) and a transmission network (9, 9a), comprising: a center sender (1) receiving multicast data having a particular multicast address from a LAN (6) to which a multicast server (4) capable of sending multicast data to the LAN is connected and relaying the multicast data to the transmission network; and a filter unit (3) that is connected between the LAN and the IP network and prevents the multicast data having the particular multicast address from being sent to the IP network.

According to another aspect of the present invention, there is provided a communication apparatus (30) connectable to both an IP network (8) and a transmission network (9, 9a), comprising: center senders (1₁˜1ₙ) receiving multicast data of respective particular multicast addresses different from one another via a LAN and sending the multicast data thus received to the transmission network at respective different frequencies (f₁˜fₙ) ; and a filter unit (3) that is connected between the LAN and the IP network and prevents the multicast data of said respective particular multicast addresses from being sent to the IP network.

According to a still further aspect of the present invention, there is provided a communication apparatus (40) connectable to a transmission network (9, 9a) and a subscriber LAN to which an IP network (8) is connected, comprising: a first part (2b, 2c) receiving and sending a group management protocol for multicast from and to the subscriber LAN; a second part (2a) receiving a signal from the transmission network; and a third part (2d, 2e) controlling sending of data to the IP network in accordance with information contained in the group management protocol.

The communication apparatus may be configured so that the third part includes: a monitor part (2d) detects, from the group management protocol, a multicast address to be sent to the subscriber LAN; and a filter part (2e) sending data of the multicast address detected by the monitor part to the first part.

According to another aspect of the present invention, there is provided a communication apparatus (40) connectable to a transmission network (9, 9a) and an IP network (8), including: a first part (2b, 2c) receiving and sending a group management protocol for multicast from and to a subscriber LAN to which the 2p network is connected; a second part (2f) describing a relationship between multicast addresses and receiving frequencies on the transmission network; and a third part (2d) extracting a multicast address from information contained in the group management protocol, and searching the second part for one of the receiving frequencies corresponding to the multicast address thus extracted; and fourth part (2a) receiving a signal of said one of the receiving frequencies from the transmission network and sending data of multicast address extracted by the third part to the first part According to another aspect of the present invention, there is provided a communication method applied to a network configuration in which a center (30) and subscriber systems (40) are connected by both an IP network (8) and a transmission network (9, 9a), said communication method comprising the steps of: receiving multicast data of a particular multicast address via a center LAN to which a multicast server capable of sending multicast data is connected and relaying the multicast data thus received to the transmission network; preventing the multicast data of the particular multicast address from being sent to the IP network; and receiving the multicast data from the transmission network and sending the multicast data to a subscriber LAN to which the IP network and a multicast receiver terminal are connected.

According to yet another aspect of the present invention, there is provided a communication apparatus (30) connectable to both an IP network (8) and a transmission network (9, 9a), including: a switch (51) switching data between a LAN (6) to which a multicast server (4) is connected and the IP network and between the LAN and the transmission network; and a routing table (52) storing routing information that defines a routing operation of the switch, the routing information being described so that multicast data of a particular multicast address can be prevented from being sent to the IP network. By utilizing switching or routing, it is possible to prevent multicast data of the particular multicast address from being sent to the IP network and to bypass the IP network.

The communication apparatus may be configured so that the table can be updated via the transmission network or the subscriber LAN to which the IP network is connected.

According to another aspect of the present invention, there is provided an IP multicast relay system including: a center (30) and subscriber systems (40) connected thereto via both an IP network (8) and a transmission network (9, 9a); a center sender (50) provided in the center, the center sender receiving multicast data having a particular multicast address via a center LAN to which a multicast server (4) that sends multicast data to the center LAN is connected and relaying the multicast data thus received to the transmission network, while preventing the multicast data from being sent to the IP network; and a receiver unit (2) provided in the subscriber system, the receiver unit receiving the multicast data via the transmission network and sending the multicast data thus received to a subscriber LAN (7) to which the IP network and a multicast receiver terminal (5) are connected.

The IP multicast relay system may be configured so that the center sender comprises: a switch (51) switching data between the LAN and the IP network and between the LAN and the transmission network; and a routing table (52) storing routing information that defines a routing operation of the switch, the routing information being described so that multicast data of the particular multicast address can be prevented from being sent to the IP network.

According to another aspect of the present invention, there is provided a communication apparatus (30) connectable to an IP network (8) and a transmission network (9, 9a), comprising: means (50) for sending multicast data of a particular multicast address to the transmission network and preventing the multicast data from being sent to the IP network.

According to another aspect of the present invention, there is provided a communication apparatus connectable to an IP network (8) and a transmission network (9, 9a), comprising: means (2) for receiving multicast data via the transmission network and relying multicast data of a particular multicast address to a LAN connectable to the IP network.

The communication apparatus may be configured so that the above means receives the multicast data at a tunable frequency (f₁-fₙ).

According to another aspect of the present invention, there is provided an IP multicast relay system including: a center (30) and subscriber systems (40) connected by an IP network (8); and a transmission network (9) connecting the center and the subscriber systems, multicast data of a particular multicast address bypassing the IP network and being sent to the subscriber systems via the transmission network.

The present application is based on Japanese Patent Application Nos. 2001-331578 and 2002-282018 filed on Oct. 28, 2001 and Sep. 26, 2002, respectively, the entire disclosure of which is hereby incorporated by reference.

Although some preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An IP multicast relay system comprising:
a center and subscriber systems connected thereto via both an IP network and a transmission network;
a center sender provided in the center, the center sender receiving multicast data having a particular multicast address via a center LAN to which a multicast server that sends multicast data to the center LAN is connected and relaying the multicast data thus received to the transmission network;
a filter unit that is connected between the center LAN and the IP network and prevents the multicast data having the particular multicast data from being sent to the IP network; and
a receiver unit provided in the subscriber system, the receiver unit receiving the multicast data via the transmission network and sending the multicast data thus received to a subscriber LAN to which the IP network and a multicast receiver terminal are connected.

2. The IP multicast relay system according to claim 1, wherein the receiver unit comprises means for receiving and sending group management protocol for multicast from and to the subscriber LAN and controlling sending of data to the subscriber LAN in accordance with information contained in the group management protocol.

3. The IP multicast relay system according to claim 1, wherein:
the center includes center senders that accept multicast data of respective particular multicast addresses different from one another and send multicast data to the transmission network at respective different frequencies;
the receiver unit includes means for receiving and sending group management protocol for multicast from and to the subscriber LAN and a table that defines a relationship between multicast addresses and receiving frequencies on the transmission network; and
the receiver unit extracts the multicast address from information contained in the group management protocol, and searches the table for one of the receiving frequencies corresponding to the multicast address thus extracted, the receiver unit receiving the multicast data at said one of the receiving frequencies.

4. The IP multicast relay system according to any of claims 1 to 3, further comprising a part that is provided in the IP network and prevents data having the particular multicast address from flowing in the IP network.

5. The IP multicast relay system according to any of claims 1 to 3, further comprising a part that is provided in the subscriber LAN and prevents data having the particular multicast address from being forwarded to the IP network.

6. A communication apparatus connectable to both an IP network and a transmission network, comprising:
a center sender receiving multicast data having a particular multicast address from a LAN to which a multicast server capable of sending multicast data to the LAN is connected and relaying the multicast data to the transmission network; and
a filter unit that is connected between the LAN and the IP network and prevents the multicast data having the particular multicast address from being sent to the IP network.

7. A communication apparatus connectable to both an IP network and a transmission network, comprising:
center senders receiving multicast data of respective particular multicast addresses different from one another via a LAN and sending the multicast data thus received to the transmission network at respective different frequencies; and
a filter unit that is connected between the LAN and the IP network and prevents the multicast data of said respective particular multicast addresses from being sent to the IP network.

8. A communication apparatus connectable to a transmission network and a subscriber LAN to which an IP network is connected, comprising:
a first part receiving and sending a group management protocol for multicast from and to the subscriber LAN;
a second part receiving a signal from the transmission network; and
a third part controlling sending of data to the IP network in accordance with information contained in the group management protocol.

9. The communication apparatus according to claim 8, wherein the third part comprises:
a monitor part detects, from the group management protocol, a multicast address to be sent to the subscriber LAN; and
a filter part sending data of the multicast address detected by the monitor part to the first part.

10. A communication apparatus connectable to a transmission network and a subscriber LAN to which an IP network is connected, comprising:
a first part receiving and sending a group management protocol for multicast from and to the subscriber LAN;
a second part describing a relationship between multicast addresses and receiving frequencies on the transmission network; and
a third part extracting a multicast address from information contained in the group management protocol, and searching the second part for one of the receiving frequencies corresponding to the multicast address thus extracted; and a fourth part receiving a signal of said one of the receiving frequencies from the transmission network and sending data of multicast address extracted by the third part to the first part.

11. A communication method applied to a network configuration in which a center and subscriber systems are connected by both an IP network and a transmission network, said communication method comprising the steps of:
receiving multicast data of a particular multicast address via a center LAN to which a multicast server capable of sending multicast data is connected and relaying the multicast data thus received to the transmission network;
preventing the multicast data of the particular multicast address from being sent to the IP network; and
receiving the multicast data from the transmission network and sending the multicast data to a subscriber LAN to which the IP network and a multicast receiver terminal are connected.

12. A communication apparatus connectable to both an IP network and a transmission network, comprising:
a switch switching data between a LAN to which a multicast server is connected and the IP network and between the LAN and the transmission network; and
a routing table storing routing information that defines a routing operation of the switch,
the routing information being described so that multicast data of a particular multicast address can be prevented from being sent to the IP network.

13. The communication apparatus according to claim 10, wherein the table can be updated via the transmission network or the subscriber LAN to which the IP network is connected

14. An IP multicast relay system comprising:
a center and subscriber systems connected thereto via both an IP network and a transmission network;
a center sender provided in the center, the center sender receiving multicast data having a particular multicast address via a center LAN to which a multicast server that sends multicast data to the center LAN is connected and relaying the multicast data thus received to the transmission network, while preventing the multicast data from being sent to the IP network; and
a receiver unit provided in the subscriber system, the receiver unit receiving the multicast data via the transmission network and sending the multicast data thus received to a subscriber LAN to which the IP network and a multicast receiver terminal are connected.

15. The IP multicast relay system according to claim 14, wherein the center sender comprises:
a switch switching data between the LAN and the IP network and between the LAN and the transmission network; and
a routing table storing routing information that defines a routing operation of the switch,
the routing information being described so that multicast data of the particular multicast address can be prevented from being sent to the IP network.

16. The IP multicast relay system according to claim 14 or claim 15, further comprising a part that is provided in the IP network and prevents data having the particular multicast address from flowing in the IP network.

17. The IP multicast relay system according to either claim 14 or claim 15, further comprising a part that is provided in the subscriber LAN and prevents data having the particular multicast address from being forwarded to the IP network.

18. A communication apparatus connectable to an IP network and a transmission network, comprising:
means for sending multicast data of a particular multicast address to the transmission network and preventing the multicast data from being sent to the IP network.

19. A communication apparatus connectable to an IP network and a transmission network, comprising:
means for receiving multicast data via the transmission network and relying multicast data of a particular multicast address to a LAN connectable to the IP network.

20. The communication apparatus according to claim 19, wherein said means receives the multicast data at a tunable frequency.

21. An IP multicast relay system comprising:
a center and subscriber systems connected by an IP network; and
a transmission network connecting the center and the subscriber systems,
multicast data of a particular multicast address bypassing the IP network and being sent to the subscriber systems via the transmission network.
